(19) United States
(12) Patent Application Publication
(10) Pub. No.: US 2014/0049520 A1
(43) Pub. Date: Feb. 20, 2014

(54) Mobile Interactive Projection System With Multi-Pen Input

(71) Applicant: Darius Lam, Fountain Valley, CA (US)

(72) Inventor: Darius Lam, Fountain Valley, CA (US)

(21) Appl. No.: 13/585,134

(22) Filed: Aug. 14, 2012

(51) Int. Cl. G06F 3/033

(52) U.S. Cl. 345/179

(57) ABSTRACT

A mobile projection system consisting of a projector and an infrared camera positioned on top of the projector with a clear view of the projection when the projector is powered. The device allows, when proper software is installed, multi-pen input support enabling the user(s) to interact with the computer on the projected surface.

### FIELD OF THE INVENTION

The present invention relates to the field of human computer interaction and natural user interfaces. It also, more specifically, relates to a mobile interactive projector.

### DESCRIPTION OF THE RELATED ARTS

Education needs to be interactive and intriguing in order for students to be engaged and excited about learning. Interactive projectors, for example, provide teachers with the ability to interact with their computer, without actually touching it. However, these interactive projectors are costly and are usable by only one person at a time. These two factors limit much of the potential of an interactive projector. A solution which can provide low cost and multi-user support is needed.

Interactive projectors have been around for many years. However, these systems allow only for one pen input. The pen, dubbed the “magic pen”, is used to control the computer. However, when multi user input is needed, these projectors do not provide. Multi-touch desks have been proposed for this use. They allow for a multi-user, multi-touch environment. These systems are extremely costly though. They are many times the cost of an interactive projector. Their screen size is also small. A larger, wall sized multi-touch setup is tremendously expensive; much more expensive than that of a multi-touch desk. This limits educational facilities greatly, especially for the public education system. Therefore, a low-cost, multi-pen input device is needed.

### SUMMARY OF INVENTION

It is one of the primary objectives of the present invention to provide a mobile projection system allowing the user multi-pen-input.

According to the present invention, a projector system is provided. The projector system is, in itself, a system within the complete projection system. The projector system is composed of a projector and an infrared camera which is attached to the projector at an angle and distance so that it is able to detect infrared light within a space no less than that of the projection when the projector is powered. The infrared camera must also be able to connect to the user's computing device and be used by the software described below. The present invention projector system further comprises of a case capable of securely holding both projector and infrared camera in place, as to prevent damage to the projector system.

In a further aspect of the invention, a software package is provided. The software package is comprised of: (a) A software able to detect and collect data from the infrared camera described previously and able to isolate infrared shapes emitted from an infrared pen. Accordingly, the software will need contain filters capable of reducing or eliminating infrared noise and provide those filters for the user to configure. The software must also be able to communicate in a way such that software “b” can accept its communications. (b) A software able to interpret and translate communications from software “a” into computer movements. This allows for the user to access and manipulate their computer using an infrared pen.

In yet another aspect of the present invention, an infrared pen is provided. The infrared pen must contain an infrared LED within and an adequate power supply. It must also have the infrared led emit infrared light that can be detected by the infrared camera and not have the infrared light be blocked by an object such as the case.

Although the summary description may be of use to one who is skilled in the art and who wishes to learn how to practice the invention, it will be recognized that the summary is not intended to be a list of all the features and advantages. To one who is skilled in the art, viewing the drawing, specification, and claims will make apparent many additional features and advantages.

### BRIEF DESCRIPTION OF DRAWINGS

FIG. 1 is a diagram showing the projector system along with an infrared pen.

FIG. 2 depicts the interaction between the infrared pen and the movements controlling the computing device.

FIG. 3 is another diagram describing the actions of the software package and how movements of the infrared pen can translate into controlling movements of the computing device.

### DETAILED DESCRIPTION:

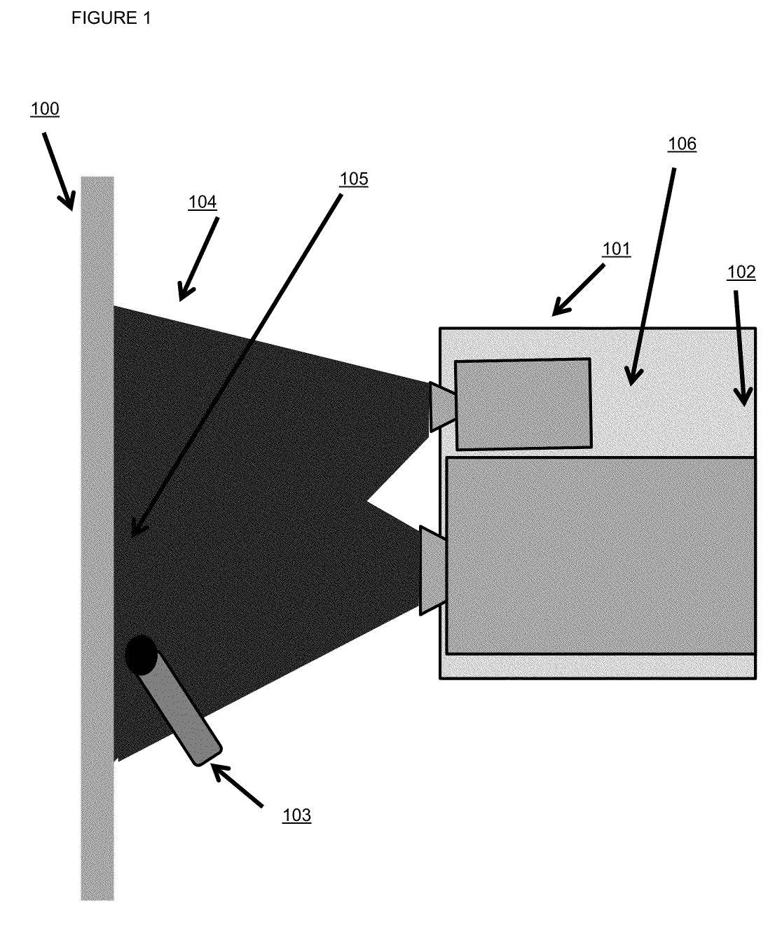

FIG. 1 depicts the projector system in use. The projector 102 is placed under the infrared camera 101. However, the placement of both the projector and the infrared camera does not have to be as illustrated in the diagram. As long as the infrared camera can view (104) the entire projection of the projector (105), the placement of both the projector and the infrared camera are irrelevant. The infrared pen 103 must also be able to be viewed by the infrared camera 101 when in use. The case 106 enclosing and protecting the projector 102 and the infrared camera 101 must not block the projection capabilities of the projector 102 and the viewing capabilities of the infrared camera 101. The projection surface 100 must not be fully transparent, though it can be semi-transparent.

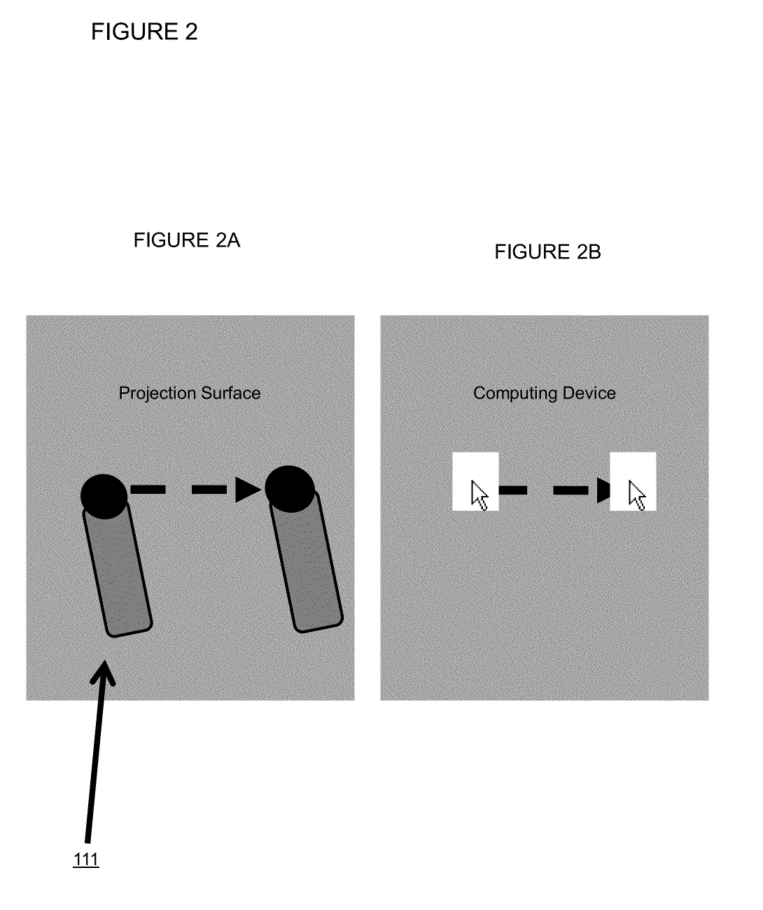

FIG. 2 is a diagram showing the translation between movement of the infrared pen and movement on the computing device. FIG. 2A depicts the movement of the infrared pen 111 and FIG. 2B shows the movement on the computing device. The movement on the computing device mimics the movement of the infrared pen 111.

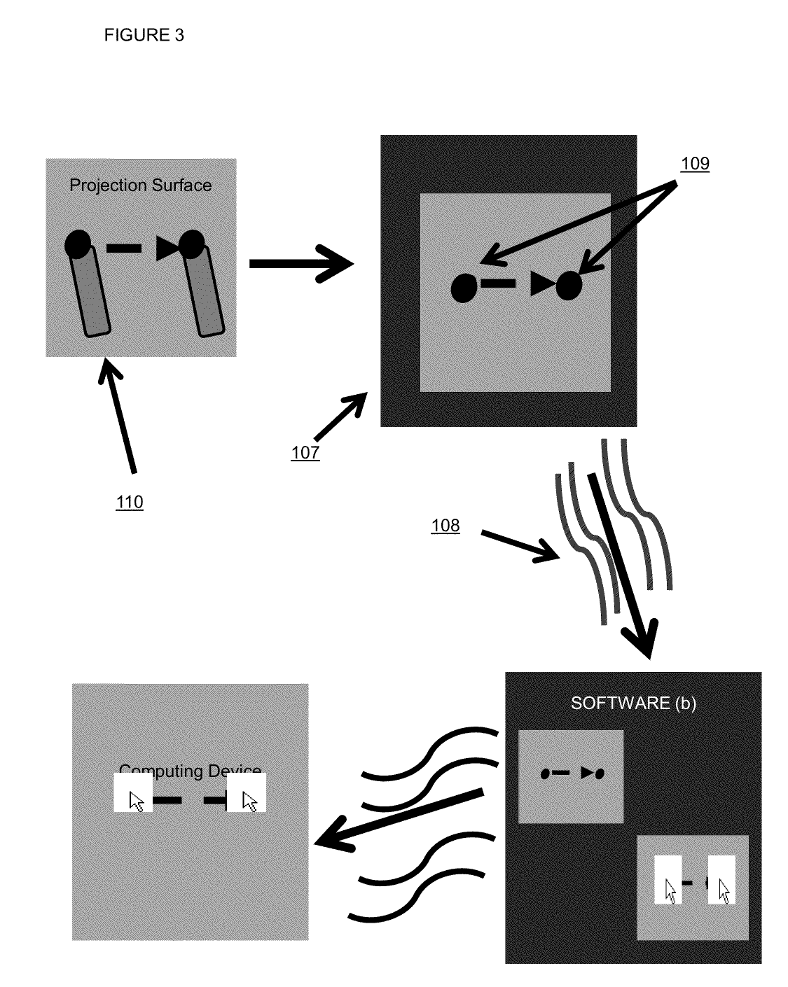

FIG. 3 is an in-depth diagram showing how the movements of the infrared pen 110 on the projection surface can result in movements of the computing device. As the infrared pen 110 moves, the infrared camera picks up the movement. However, the infrared camera only picks up the infrared dots 111 emitted by the infrared pen 110. The infrared camera can also pick up infrared noise. The infrared camera transmits the data, infrared dots 111 and infrared noise to software a. Software (a) then, with its filters, sorts out all the infrared noise, leaving only the infrared dots 111. Software (a) then communicates 108 with software (b) where the movements of the infrared dots 111 are translated into movements on the computing device. Software (b) then transmits messages to the computing device, which, in response, move the controlling movement of the computing device, an example of which would be a mouse cursor.

The invention is claimed as follows:

1. A projection device comprising: a projector able to connect to a user's computing device; and an infrared camera capable of connecting to the user's computing device to: (a) Project the graphical state of the computing device onto a solid, partially or fully transparent material surface. (b) Be able to detect infrared light emitted from an infrared pen.

2. A software package comprising: (a) A software able to isolate and track infrared light emitted from an infrared pen and communicate with (b) a software capable of translating communications from software “a” into movements on the computing device.
